(19) United States
(12) Patent Application Publication
(10) Pub. No.: US 2025/0130435 A1
(43) Pub. Date: Apr. 24, 2025

(54) OPTICAL ELEMENT, OPTICAL SYSTEM, DISPLAY APPARATUS, AND MANUFACTURING METHOD OF OPTICAL ELEMENT

(71) Applicant: CANON KABUSHIKI KAISHA, Tokyo (JP)

(72) Inventor: Toru YATABE, Tochigi (JP)

(21) Appl. No.: 18/889,445

(22) Filed: Sep. 19, 2024

(30) Foreign Application Priority Data
Oct. 20, 2023 (JP) 2023-180972

(51) Int. Cl. G02B 27/28

(52) U.S. Cl. CPC G02B 27/288

(57) ABSTRACT

An optical element includes a substrate having a curved surface, a plurality of convex portions arranged on the curved surface in a first direction, and a metal layer provided on each side surface of the plurality of convex portions. Each of the plurality of convex portions extends in a second direction perpendicular to the first direction. A predetermined inequality is satisfied.

### BACKGROUND

### Technical Field

The present disclosure relates to an optical element, an optical system, a display apparatus, and a manufacturing method of an optical element.

### Description of Related Art

Technologies have recently been proposed for using an optical element having a polarization selective transmissive reflective function on a curved surface in a display apparatus such as a head mount display (HMD) or an electronic viewfinder (EVF). Using the optical element having the polarization selective transmissive reflective function on the curved surface can reduce the size of the optical system and improve the design freedom. Japanese Patent Laid-Open No. 2022-165579 discloses an optical element configured by joining a film having a polarization selective transmissive reflective function with an optical surface having a curved surface of an optical element.

### SUMMARY

An optical element according to one aspect of the disclosure includes a substrate having a curved surface, a plurality of convex portions arranged on the curved surface in a first direction, and a metal layer provided on each side surface of the plurality of convex portions. Each of the plurality of convex portions extends in a second direction perpendicular to the first direction. The following inequality may be satisfied:

$$0 \leq \vert ΔθS \vert \leq 15$$

where |Δθs|) (°) is an absolute value of a maximum angle difference between central axes of the plurality of convex portions when viewed from the second direction. An optical system and display apparatus each having the above optical element also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are a sectional view and a top view of an optical element according to Example 1.

FIG. 2 is an enlarged sectional view of the optical element according to Example 1.

FIGS. 3A and 3B explain optical elements according to a comparative example and Example 1.

FIGS. 4A and 4B explain a manufacturing method of the optical element according to Example 1.

FIG. 5 is a sectional view of an optical element according to Example 2.

FIG. 6 is a sectional view of a display apparatus according to each Example.

### DETAILED DESCRIPTION

Referring now to the accompanying drawings, a detailed description will be given of examples according to the disclosure. The drawings illustrated below may be drawn at a different scale from the actual one for easy understanding of each example.

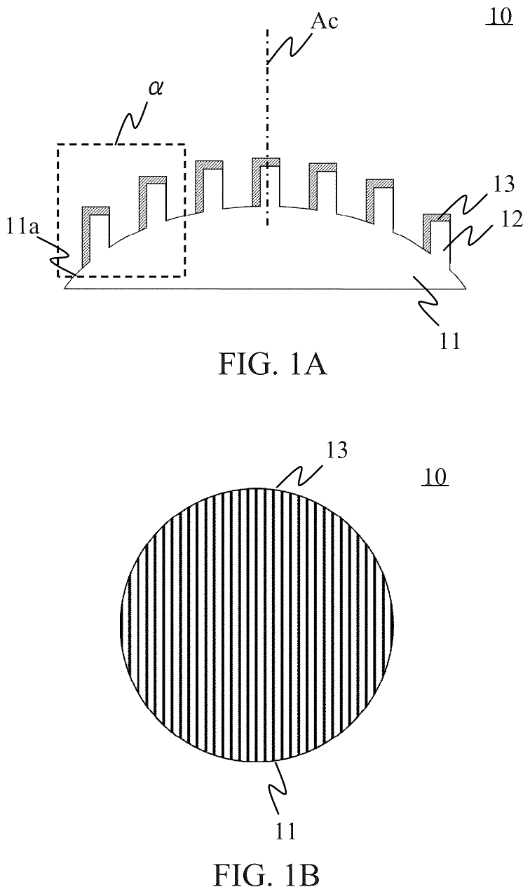

An optical element according to each example has a polarization selective transmissive reflective function, and includes a plurality of convex portions extending in one direction (second or vertical direction in FIG. 1B) on a surface of a curved shape, and a metal layer covering at least a part of each of the plurality of convex portions. Due to this configuration, the optical element according to each example can reflect or transmit light according to the polarization state of the light. The optical element according to each example has, for example, a structure in which thin metal wires (metal layers) are arranged at specific intervals (or distances), reflects light vibrating in a direction parallel to the thin metal wires, and transmits light vibrating in a direction perpendicular to the thin metal wires.

Referring now to FIGS. 1A and 1B, a description will be given of an overview of an optical element 10 according to each example. FIG. 1A is a sectional view of the optical element 10, and FIG. 1B is a top view of the optical element 10. A substrate 11 is, for example, a transparent substrate, and one optical surface (front surface) 11a of the substrate 11 has a curved shape as illustrated in FIG. 1A. A plurality of convex portions (uneven structure) 12 are arranged on an optical surface 11a. The metal layer 13 covers at least a part of the plurality of convex portions 12. As illustrated in FIG. 1B, when viewed from a direction of a central axis Ac of the convex portions 12, the plurality of convex portions 12 covered with the metal layer 13 are arranged substantially parallel to each other along a specific direction (first or horizontal direction in FIGS. 1A and 1B). That is, the optical element 10 includes the substrate 11 including the curved surface, and the plurality of convex portions 12 arranged on the curved surface in a first direction.

In each example, the plurality of convex portions 12 may be arranged on at least one surface (optical surface) of the substrate 11, or may be arranged on both surfaces of the substrate 11. In each example, at least one surface of the substrate 11 may be a curved surface, or both surfaces of the substrate 11 may be curved surfaces. In each example, the metal layer 13 may be formed on at least a part of each of the plurality of convex portions 12, and may be formed only on one side surface or only on the top surface (top) of each of the convex portions 12. Alternatively, the metal layer 13 may be formed only on both side surfaces or both side surfaces and the top surface of each of the convex portions 12. However, at least a part of the optical surface (corresponding to the concave portion) located between two adjacent convex portions 12 is not covered with the metal layer 13.

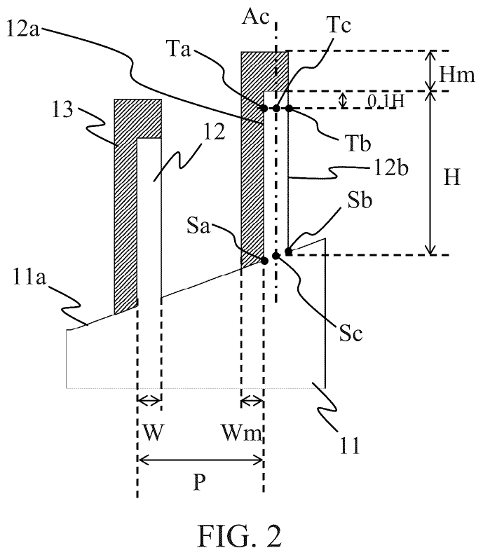

Referring now to FIG. 2, a detailed description will be given of the configuration of the optical element 10. FIG. 2 is an enlarged sectional view of a region a in FIG. 1A.

In each example, the following inequality (1) may be satisfied:

$$0 < P \leq 300 \qquad ( 1 )$$

where P (nm) is a pitch of the plurality of convex portions 12 (a distance between two adjacent convex portions).

In a case where the pitch P becomes higher than 300 nm, unnecessary diffracted light occurs.

Inequality (1) may be replaced with inequality (la) below:

$$20 \leq P \leq 250 \qquad ( 1 a )$$

Inequality (1) may be replaced with inequality (1b) below:

$$50 \leq P \leq 150 \qquad ( 1 b )$$

As illustrated in FIG. 2, Sa and Sb are points (intersections) where side surfaces 12a and 12b of each convex portion 12 intersect the optical surface 11a, respectively, Sc is a midpoint between points Sa and Sb, and H is a distance from the midpoint Sc to the top (highest position) of the convex portion 12 (the height of the convex portion 12). Tc is a midpoint of points Ta and Tb on the side surfaces 12a and 12b of the convex portion 12 at a position 0.1H downward from the top of the convex portion 12. An imaginary line passing through Sc-Tc is a central axis Ac. The direction of the central axis Ac includes a direction of the central axis of an arbitrary convex portion among the plurality of convex portions 12, and the direction along the central axis of one representative convex portion (for example, the center of the optical element 10) among the plurality of convex portions 12 is called a central axis direction. Each of the first direction and the second direction is perpendicular to the central axis Ac of a convex portion at the center of the optical axis 10, which is a reference axis.

At this time, in each example, an absolute value | 40s|) (° of a maximum angle difference (maximum value of an angle difference between the central axes of any two convex portions) of the convex portions 12 when viewed from a second direction may satisfy the following inequality (2). Here, an “angle” indicates, for example, an angle between a reference axis (angle 0 degrees) of the central axis of the central convex portion in the optical element 10 and the other convex portion, and the angle is a positive value on one side and a negative value on the other side:

$$0 \leq \vert Δθ s \vert \leq 15 \qquad ( 2 )$$

Inequality (2) may be replaced with inequality (2a) below:

$$0 \leq \vert Δθ s \vert \leq 10 \qquad ( 2 a )$$

Inequality (2) may be replaced with inequality (2b) below:

$$0 \leq \vert Δθ s \vert \leq 5 \qquad ( 2 b )$$

In each example, the following inequality (3) may be satisfied:

$$0.3 \leq ( W + Wm ) / P \leq 0.6 \qquad ( 3 )$$

where W (nm) is a maximum width of the plurality of convex portions 12 in the first direction, and Wm (nm) is a maximum width of the metal layer 13 (metal layer 13 formed on the side surface) of the plurality of convex portions 12 in the first direction.

In a case where the value becomes lower than the lower limit of inequality (3), the S-polarized light reflectance and the optical performance lower. On the other hand, in a case where the value becomes higher than the upper limit of inequality (3), the P-polarized light transmittance and the optical performance lower.

Inequality (3) may be replaced with inequality (3a) below:

$$0. 2 \leq ( W + Wm ) / P \leq 0.5 \qquad ( 3 a )$$

Inequality (3) may be replaced with inequality (3b) below:

$$0.1 \leq ( W + Wm ) / P \leq 0.4 \qquad ( 3 b )$$

In a case where the metal layer 13 is formed on both side surfaces 12a and 12b of the convex portion 12, the maximum width Wm of the metal layer 13 in inequalities (3), (3a), and (3b) is the sum of the widths formed on side surfaces 12a and 12b.

The metal layer 13 may be made of a material that has a high reflectance in the visible light region (e.g., wavelengths of 400 to 700 nm). The metal layer 13 is made, for example, of an alloy whose main component is at least one of aluminum, silver, copper, chromium, and gold. From the standpoint of durability and low cost, the metal layer 13 may be made of aluminum.

In each example, the following inequality (4) may be satisfied:

$$0 < \vert θ1 \vert < 40 \qquad ( 4 )$$

where |θ1|) (°) is an absolute value of a maximum half-open angle of the curved surface of the optical element.

Here, the maximum half-open angle is a maximum angle between the center line (optical axis) of the optical element and the surface normal at an arbitrary position within the effective diameter of the optical element. In a case where the value becomes higher than the upper limit of inequality (4), the in-plane variation of the metal layer 13 increases.

Inequality (4) may be replaced with inequality (4a) below:

$$0 < \vert θ1 \vert < 30 \qquad ( 4 a )$$

Inequality (4) may be replaced with inequality (4b) below:

$$0 < \vert θ1 \vert < 25 \qquad ( 4 b )$$

The substrate 11 and the convex portions 12 may be made of a single member (same material). The substrate 11 and the convex portions 12 may be made of a resin material whose main component is thermoplastic resin such as polycarbonate resin, polymethacrylic acid acrylic resin, and cycloolefin polymer resin. Cycloolefin polymer resin may have low water absorption. Here, the main component means that it contains 51% or more, or 90% or more, by a mass ratio.

### Example 1

A description will now be given of the optical element 10 according to Example 1. The optical element 10 includes a substrate 11 having a spherical shape, as illustrated in FIG. 1. One surface (optical surface 11a) of the substrate 11 has a spherical shape with a radius of curvature of 115.2 mm, and a maximum half-open angle |θ1| is 10°. An optical surface 11a has convex portions 12 with a pitch P=130 nm, a height H of the convex portion=170 nm, and a maximum width W of the convex portion 12=25 nm.

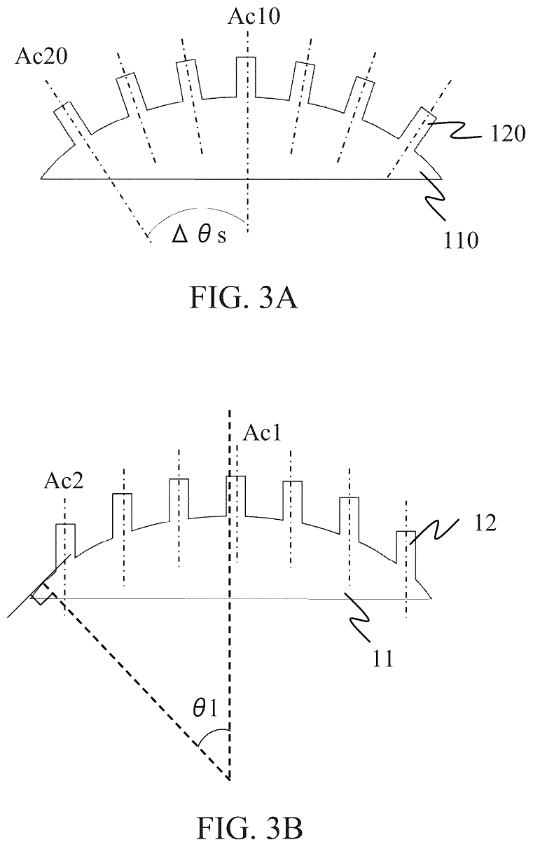

In this example, the pitch P is 300 nm or less, so that the generation of unnecessary diffracted light can be suppressed. In addition, since (W+Wm)/P is 0.37, a good polarization selective transmissive reflective function can be obtained. This example uses the substrate 11 having the spherical shape as illustrated in FIG. 3B. The maximum half-open angle |01| is 10° at the end of the effective area (effective diameter) of the optical element 10, and the in-plane variation can be suppressed.

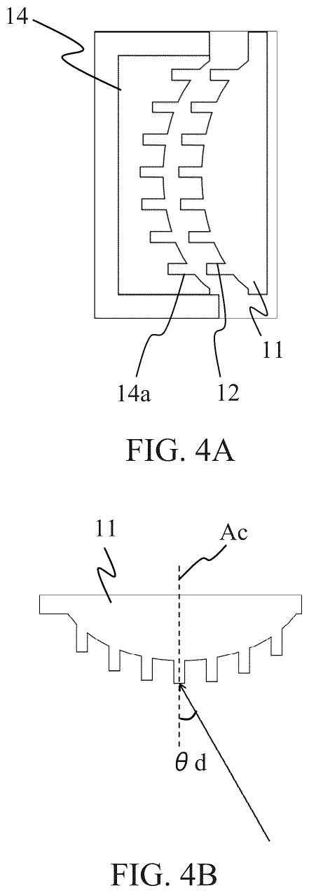

FIGS. 4A and 4B explain a manufacturing method of the optical element 10 according to this example. As illustrated in FIG. 4A, the substrate 11 and the convex portions 12 are molded by injection molding using cycloolefin polymer resin. In the injection molding, an injection molding piece 14 is used on which the optical surface 11a and inverted convex portions 14a of the convex portions 12 are formed. A photoresist is formed on the injection molding piece 14, and the inverted convex portions 14a can be formed on the curved shape of the injection molding piece 14 by patterning and dry etching using a two-beam interference exposure method. The injection molding piece 14 having the inverted convex portions 14a is incorporated into an injection molding device, and the substrate 11 having the convex portions 12 formed on an optical surface 11a by injection molding can be obtained.

Thus, in this example, the substrate 11 and the plurality of convex portions 12 are integrally molded by injection molding. Next, the metal layers 13 are formed on at least a portion of each of the convex portions 12 by performing vacuum deposition from an oblique direction relative to the direction of the central axis Ac of each of the convex portions 12. Thereby, the optical element 10 can be manufactured.

FIG. 3A illustrates the configuration of a substrate 110 and a plurality of convex portions 120 according to a comparative example in which |Δθs| does not satisfy inequality (2). On the other hand, FIG. 3B illustrates the configuration of this example in which |Δθs| satisfies inequality (2). The plurality of convex portions 120 in FIG. 3A cannot be stably molded because a central axis Ac10 and a central axis Ac20 are not parallel. On the other hand, the plurality of convex portions 12 in FIG. 3B can be stably molded because the central axis Ac1 and central axis Ac2 are approximately parallel. Thus, the substrate 11 and the convex portions 12 are integrally molded by injection molding, which allows for cost reduction.

Each metal layer 13 that covers a part of each convex portion 12 is formed by obliquely depositing aluminum at an angle θd to the central axis Ac of the convex portion 12 by vacuum deposition so that the maximum width Wm is 23 nm. Thereby, the metal layer 13 can be formed so as to cover at least a part of each convex portion 12.

The polarization degree is evaluated as the polarization selective transmissive reflective function for the optical element 10 according to this example. Light is incident from the convex portions 12 side, and the polarization degree (%) is evaluated as follows using parallel transmittance Tp and orthogonal transmittance Ts at a wavelength of 550 nm:

$$Polarization degree ( \% ) = ( T p - Ts ) / ( Tp + T s ) \times 100$$

Table 1 illustrates the results.

Example 1

| Substrate Shape | | | Spherical Surface |
|---|---|---|---|
| Maximum Half-Open Angle | θ1 | ° | 10 |
| Convex Height | H | nm | 170 |
| Convex Width | W | nm | 25 |
| Metal Layer Width | Wm | nm | 23 |
| Pitch | P | nm | 130 |
| (W + Wm)/P | FF | — | 0.37 |
| Polarization Degree (Center) | | % | 99.9 |
| Polarization Degree (End: Center + | | % | 99.9 |
| 18 mm) | | | |

As illustrated in Table 1, the optical element 10 has a high polarization degree of 99.9% or more at both the central portion and the end portion. Due to this structure, the optical element 10 can obtain good optical performance at low cost without reducing the surface accuracy of the optical surface 11a.

This example uses the two-beam interference exposure method in the process of manufacturing the uneven structure on the curved surface shape of the injection molding piece, but is not limited to this example, and may use, for example, an electron beam exposure method. This example forms the metal layer 13 by vacuum deposition, but is not limited to this example, and may use a sputtering or wet method.

### Example 2

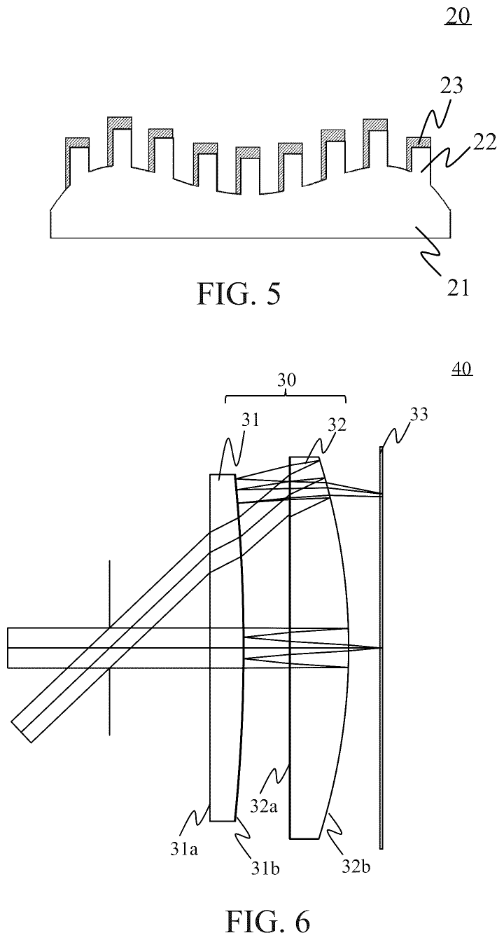

A description will now be given of an optical element 20 according to Example 2. FIG. 5 is a sectional view of the optical element 20. As illustrated in FIG. 5, the optical element 20 includes a substrate 21 with an aspherical shape. One surface of the substrate 21 (optical surface 21a) has an aspherical shape, and a maximum half-open angle |θ1|=20°. Convex portions 22 are formed on an optical surface 21a with a pitch P of 100 nm, height H of each convex portion 22 of 139 nm, and maximum width W of each convex portion 22 of 27 nm. A metal layer 23 covering at least a part of each convex portion 22 is deposited so that the maximum width Wm is 30 nm.

In this example, the pitch P is 300 nm or less, so that the generation of unnecessary diffracted light can be suppressed. In addition, since (W+Wm)/P is 0.57, good optical performance can be obtained. The maximum half-open angle |01| is 20°, and the in-plane variation can be suppressed.

Table 1 illustrates the optical performance of the optical element 20.

Example 2

| Substrate Shape | | | Aspheric Surface |
|---|---|---|---|
| Maximum Half-Open Angle | θ1 | ° | 20 |
| Convex Height | H | nm | 139 |
| Convex Width | W | nm | 27 |
| Metal Layer Width | Wm | nm | 30 |
| Pitch | P | nm | 100 |
| (W + Wm)/P | FF | — | 0.57 |
| Polarization Degree (Center) | | % | 99.9 |
| Polarization Degree (End: Center + | | % | 99.9 |
| 18 mm) | | | |

As illustrated in Table 2, the optical element 20 has a high polarization degree of 99.9% or more at both the central portion and the end portion. Due to this structure, the optical element 20 can obtain good optical performance at low cost without reducing the surface accuracy of the optical surface 21a.

Each example forms only the metal layers 13 and 23 on the convex portions 12 and 22, but may form an adhesive layer between each of the convex portions 12 and 22 and each of the metal layers 13 and 23, and a protective layer on each of the metal layers 13 and 23. In addition, the adhesive layer and the protective layer are not limited to being obliquely formed, and may be formed at θd=0°

Referring now to FIG. 6, a description will be given of a display apparatus 40 including the optical element according to each example. FIG. 6 explains the display apparatus 40. The display apparatus 40 includes an optical system 30 and a display element (image display surface) 33. That is, the display apparatus 400 includes the optical element according to each example, and a display element 33 configured to emit light toward the optical element.

The optical system 30 is an observation optical system configured to guide a light beam from the display element 33 to an observer, and includes a first optical element 31 having optical surfaces 31a and 31b, and a second optical element 32 having optical surfaces 32a and 32b. For example, a plurality of convex portions 12 (or a plurality of convex portions 22) according to each example are formed on the optical surface 31b of the first optical element 31. An unillustrated quarter waveplate is disposed between the optical surfaces 31b and 32b. The quarter waveplate is bonded, for example, to the optical surface 32a.

Each example can easily provide an optical element having high optical performance, an optical system, a display apparatus, and a method for manufacturing the optical element.

While the disclosure has described example examples, it is to be understood that some examples are not limited to the disclosed examples. The scope of the following claims is to be accorded the broadest interpretation so as to encompass all such modifications and equivalent structures and functions.

This application claims priority to Japanese Patent Application No. 2023-180972, which was filed on Oct. 20, 2023, and which is hereby incorporated by reference herein in its entirety.

What is claimed is:

1. An optical element comprising:
a substrate having a curved surface;
a plurality of convex portions arranged on the curved surface in a first direction; and
a metal layer provided on each side surface of the plurality of convex portions,
wherein each of the plurality of convex portions extends in a second direction perpendicular to the first direction, and
wherein the following inequality is satisfied:
$$0 \leq \vert Δ θ s \vert \leq 15$$
where |Δθs|(°) is an absolute value of a maximum angle difference between central axes of the plurality of convex portions when viewed from the second direction.

2. The optical element according to claim 1, wherein the following inequality is satisfied:
$$0 < P \leq 300$$
where P (nm) is a pitch of the plurality of convex portions.

3. The optical element according to claim 1, wherein the following inequality is satisfied:
$$0.3 \leq ( W + Wm ) / P \leq 0.6$$
where P (nm) is a pitch of the plurality of convex portions, W is a maximum width of the plurality of convex portions in the first direction, and Wm is a maximum width of the metal layer of the plurality of convex portions in the first direction.

4. The optical element according to claim 2, wherein the following inequality is satisfied:
$$0.3 \leq ( W + Wm ) / P \leq 0.6$$
where W is a maximum width of the plurality of convex portions in the first direction, and Wm is a maximum width of the metal layer of the plurality of convex portions in the first direction.

5. The optical element according to claim 1, wherein the following inequality is satisfied:
$$0 < \vert θ1 \vert < 40$$
where |θ1|) (°) is an absolute value of a maximum half-open angle of the curved surface.

6. The optical element according to claim 1, wherein the substrate and the plurality of convex portions are made of the same material.

7. The optical element according to claim 1, wherein the substrate and the plurality of convex portions are made of a resin material.

8. The optical element according to claim 1, wherein the substrate and the plurality of convex portions are integrated.

9. The optical element according to claim 1, wherein a main component of the metal layer is at least one of aluminum, silver, copper, chromium, and gold.

10. The optical element according to claim 1, wherein the plurality of convex portions are arranged only in the first direction.

11. The optical element according to claim 1, wherein the plurality of convex portions are provided on tops of the plurality of convex portions.

12. An optical system comprising:
a plurality of optical elements,
wherein at least one of the plurality of optical elements is the optical element according to claim 1.

13. A display apparatus comprising:
the optical element according to claim 1; and
a display element configured to emit light toward the optical element.

14. An optical element manufacturing method comprising the steps of:
integrally molding a substrate including a curved surface and a plurality of convex portions arranged on the curved surface in a first direction by injection molding;
forming a metal layer on each side surface of the plurality of convex portions by performing vacuum deposition from an oblique direction relative to a direction of each central axis of the plurality of convex portions,
wherein each of the plurality of convex portions extends in a second direction perpendicular to the first direction, and
wherein the following inequality is satisfied:
$$0 \leq \vert Δ θ s \vert \leq 15$$
where |Δθs|(°) is an absolute value of a maximum angle difference between central axes of the plurality of convex portions when viewed from the second direction.

15. An optical element comprising:
a substrate having a curved surface;
a plurality of convex portions arranged on the curved surface in a first direction;
a metal layer provided on each side surface of the plurality of convex portions,
wherein each of the plurality of convex portions extends in a second direction perpendicular to the first direction.

16. The optical element according to claim 15, wherein the following inequality is satisfied:
$$0 < P \leq 300$$
where P (nm) is a pitch of the plurality of convex portions.

17. The optical element according to claim 15, wherein the following inequality is satisfied:
$$0.3 \leq ( W + Wm ) / P \leq 0.6$$
where P (nm) is a pitch of the plurality of convex portions, W is a maximum width of the plurality of convex portions in the first direction, and Wm is a maximum width of the metal layer of the plurality of convex portions in the first direction.

18. The optical element according to claim 16, wherein the following inequality is satisfied:
$$0.3 \leq ( W + Wm ) / P \leq 0.6$$
where W is a maximum width of the plurality of convex portions in the first direction, and Wm is a maximum width of the metal layer of the plurality of convex portions in the first direction.
